(19) United States
(12) Patent Application Publication
(10) Pub. No.: US 2008/0245250 A1
(43) Pub. Date: Oct. 9, 2008

(54) Gripper device in sheet-fed rotary printing press, and method of manufacturing the same

(75) Inventor: Kazuhiko Kato, Ibaraki (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KOMORI CORPORATION

(21) Appl. No.: 12/080,302

(22) Filed: Apr. 1, 2008

(30) Foreign Application Priority Data
Apr. 3, 2007 (JP) 097253/2007

(51) Int. Cl. B41F 1/28

(52) U.S. Cl. 101/408

(57) ABSTRACT

In a sheet-fed rotary printing press, a gripper device includes a gripper pad, a gripper, a plurality of projections, and a non-attaching layer. The gripper pad includes a first gripping surface. The gripper includes a second gripping surface and cooperates with the gripper pad to grip a sheet. The plurality of projections are formed at least on one of the first gripping surface and the second gripping surface. The non-attaching layer is formed at least on a region among the projections. A method of manufacturing the gripper device is also disclosed.

### BACKGROUND OF THE INVENTION

The present invention relates to a gripper device in a sheet-fed rotary printing press which grips a sheet by a gripper pad and a gripper which is opened/closed with respect to the gripper pad, and a method of manufacturing the same.

Generally, in a sheet-fed rotary printing press, a gripper device which conveys sheets by gripping them one by one is disposed in a notch in a peripheral portion of a rotary cylinder or on a shaft supported by a delivery chain. The gripper device comprises an openable/closeable gripper and a gripper pad which opposes the gripper. The gripper of the gripper device must grip each fed sheet always at the same position. If the sheet gripping position is shifted, an error or variations in image position called a registration error may occur, or the mage may be printed twice at the same position, which is called double printing. This degrades the printing quality. To prevent this, projections or stepped surfaces to increase the frictional force with respect to the sheet are formed on the respective gripping surfaces of the gripper and gripper pad which cooperate with each other to grip the sheet.

Conventionally, a gripper device is proposed in which a large number of serrations are formed on the respective gripping surfaces of a gripper and gripper pad, as disclosed in Japanese Utility Model Laid-Open No. 57-191745. A gripper device is also proposed in which gripper chips and gripper pad chips are formed on the respective gripping surfaces of a gripper and gripper pad. A gripping device is also proposed in which a deposit material layer formed of an electroplating layer is formed on the gripping surface of a gripper pad such that super-abrasives are buried almost to half their height, and the gripping force of the gripping surface of the gripper pad is increased by the super-abrasives.

In each conventional gripper device described above, a foreign substance such as paper dust produced from a sheet, powder to prevent setoff, or ink mist floating in an inking device is attached to the serrations or the gripping surface of the gripper pad. This decreases the frictional force between the serrations or super-abrasives and the sheet.

In the gripper device in which the gripper chips and gripper pad chips are formed on the respective gripping surfaces of the gripper and gripper pad, the gripper formed with the gripper chips and the gripper pad formed with the gripper pad chips must be fabricated separately, and after that the gripper and gripper pad must be integrated. This increases the number of processing steps of the gripper and gripper pad, and the number of integrating steps.

### SUMMARY OF THE INVENTION

It is an object of the present invention to provide a gripper device in a sheet-fed rotary printing press in which a decrease in frictional force between a sheet and the respective gripping surfaces of a gripper and gripper pad is prevented, and a method of manufacturing the same.

In order to achieve the above object, according to the present invention, there is provided a gripper device in a sheet-fed rotary printing press, comprising a gripper pad including a first gripping surface, a gripper which includes a second gripping surface and cooperates with the gripper pad to grip a sheet, a plurality of projections formed at least on one of the first gripping surface and the second gripping surface, and a non-attaching layer formed at least on a region among the projections.

### BRIEF DESCRIPTION OF THE DRAWINGS

FIG. 1 is a side view showing the main part of a sheet-fed rotary printing press according to the first embodiment of the present invention;

FIGS. 2A, 2B, and 2C are a side view, perspective view, and partial sectional perspective view, respectively, of the gripper of a gripper device shown in FIG. 1;

FIG. 3 is an enlarged sectional view of the main part of the gripper of the gripper device shown in FIG. 1;

FIG. 4 is a flowchart showing a method of manufacturing the gripper of the gripper device shown in FIG. 1;

FIG. 5 is an enlarged sectional view of the gripper of a gripper device showing the second embodiment of the present invention; and

FIG. 6 is an enlarged sectional view of the gripper pad of a gripper device showing the third embodiment of the present invention.

### DESCRIPTION OF THE PREFERRED EMBODIMENTS

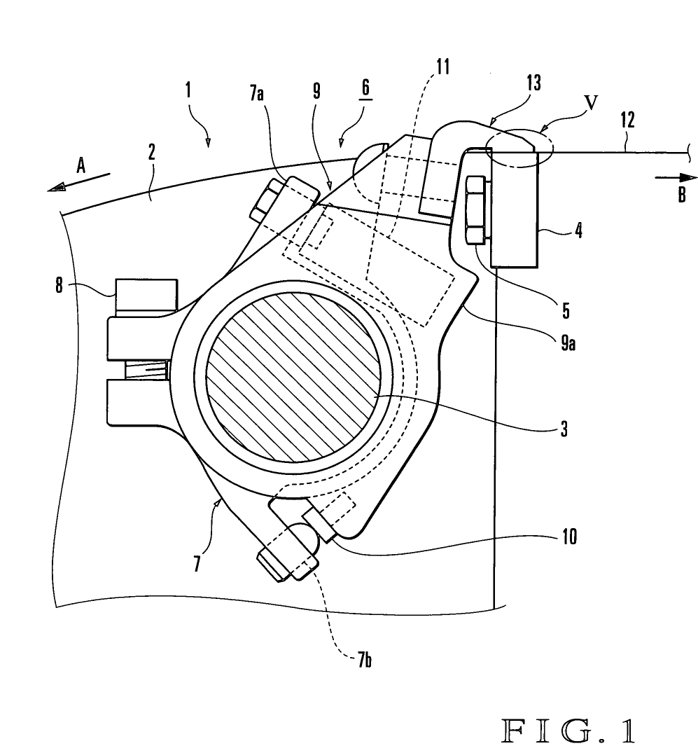

A gripper device in a sheet-fed rotary printing press according to the first embodiment of the present invention will be described in detail with reference to FIGS. 1 to 4.

As shown in FIG. 1, in a notch 2 formed in the peripheral portion of an impression cylinder 1, a gripper shaft 3 extending in the axial direction of the impression cylinder 1 is pivotally, axially supported by a bearing (not shown). A plurality of bolts 5 fix an elongated gripper pad 4, extending in the axial direction of the impression cylinder 1, to the upper portion of the wall surface of the notch 2. A plurality of gripping change devices 6 line up on the gripper shaft 3 in the axial direction to correspond to the gripper pad 4. A bolt 8 fixes a bracket 7, having a spring shoe 7a and stopper shoe 7b, to the gripper shaft 3 by split clamp.

A gripper holder 9 comprises a spring shoe 9a which opposes the spring shoe 7a, and a stopper 10 which opposes the spring shoe 7a and can be adjusted forward/backward. The gripper holder 9 is adjacent to the bracket 7, and is pivotally, axially mounted on the gripper shaft 3 while its movement in the axial direction is regulated. A gripper spring 11, which applies a pivotal force to the gripper holder 9 in the direction to separate the spring shoes 7a and 9a from each other, is elastically mounted between the spring shoes 7a and 9a. The stopper 10 regulates the pivot limit of the gripper holder 9 pivoted by the spring force of the gripper spring 11.

A gripper 13 which cooperates with the gripper pad 4 to grip a sheet 12 is fixed to the free end of the gripper holder 9 with a screw. When a cam mechanism (not shown) provided to the cylinder end of the gripper holder 9 reciprocally pivots the gripper shaft 3 through a predetermined angle, the gripper holder 9 pivots through the gripper spring 11 to open and close the gripper 13 with respect to the gripper pad 4. The impression cylinder 1 which grips the sheet 12 rotates in the direction of an arrow A in FIG. 1 to convey the sheet 12. The gripper device of the impression cylinder 1 described above has the same arrangement as that of a known sheet-fed rotary printing press.

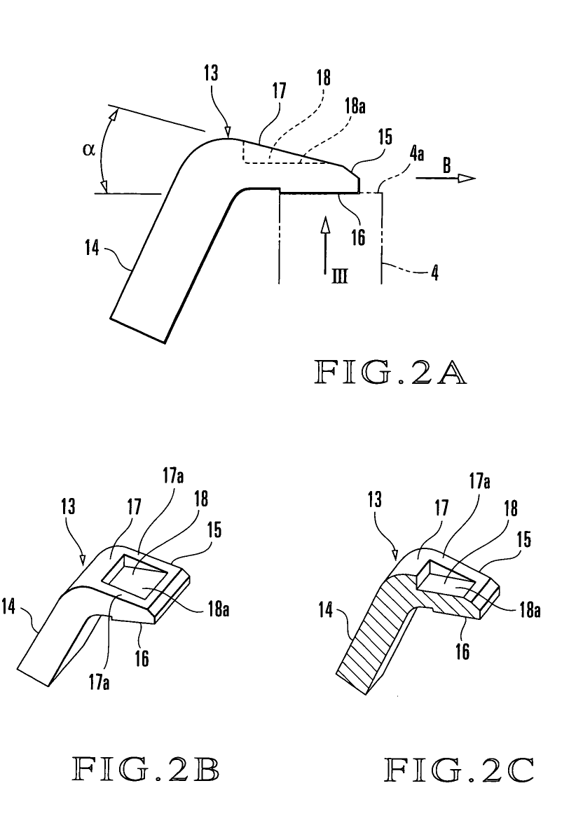

As shown in FIG. 2A, the gripper 13 with an almost inverted-L shape when seen from the side comprises a support portion 14 and a gripping portion 15 bent at the upper portion (free end) of the support portion 14. The gripping portion 15 is tapered toward its distal end (in the direction of an arrow B), when seen from the side, such that a gripping surface 16 on the lower side and an upper surface 17 form an angle α. Thus, when the sheet 12 is gripping-changed between the impression cylinder 1 provided with the gripper 13 and an opposing transfer cylinder (not shown), the distal end of the gripper 13 does not interfere with the transfer cylinder.

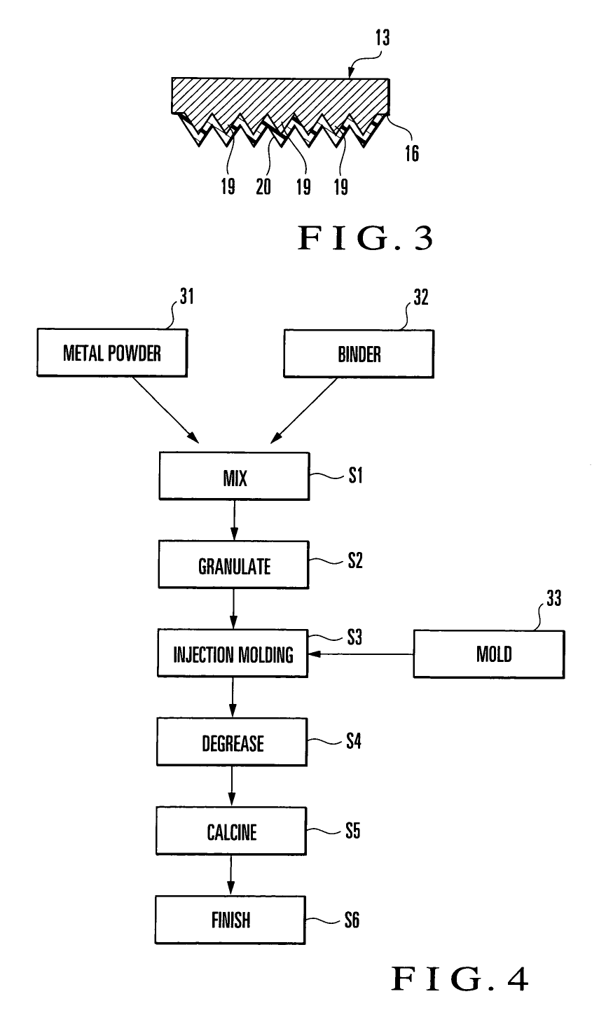

As shown in FIGS. 2B and 2C, a recess 18 with a rectangular shape when seen from the above and having a bottom surface 18a parallel to the gripping surface 16 is formed in the upper surface 17 of the gripping portion 15. A pair of ribs 17a are formed on the two sides of the upper surface 17 of the gripping portion 15. As shown in FIG. 3, a large number of conical projections 19 each having a sharp distal end, e.g., a distal end with an acute-angled section, are formed on the gripping surface 16 of the gripper 13 by metal powder injection molding. Thereby the gripper surface 16 is formed ruggedness-like.

A method of fabricating the gripper 13 having the projections 19 in accordance with metal powder injection molding will be described with reference to FIG. 4. First, a metal powder 31 as the material of the gripper 13 is mixed with a plastic material serving as a binder to make a clayish mixture (step S1). This mixture is kneaded (step S2). The mixture is injection-molded using a mold 33 to form a molded product (step S3). The obtained molded product is put in a furnace and heated to remove the plastic material from it (step S4). The molded product is heated at a temperature higher than that in a degreasing step, thus sintering the molded product (step S5). Then, the calcined molded product is subjected to finishing to improve its appearance accuracy (step S6).

According to this embodiment, as the large number of sharp-pointed projections 19 are formed on the gripping surface 16 of the gripper 13, the gripping force of the gripper 13 increases. The sheets 12 which are fed one by one are thus always gripped at the same position. As the gripping position of the sheet 12 does not shift, a registration error or double printing does not occur, thus improving the printing quality.

After finishing, the surfaces of the projections 19 formed on the gripping surface 16 of the gripper 13 are coated with fluoroplastic by baking. Thus, as shown in FIG. 3, the projections 19 are covered with a non-attaching layer 20 made of fluoroplastic. As the projections 19 are covered in this manner with the non-attaching layer 20 with a low coefficient of friction, attaching of a foreign substance such as the paper dust, powder, and ink mist to the surfaces of the projections 19 is suppressed. Consequently, a decrease in frictional force caused by such a foreign substance can be prevented.

As the gripper 13 having the projections 19 is fabricated by metal powder injection molding, machining such as cutting or polishing becomes unnecessary, thus decreasing the number of machining steps and the manufacturing cost. Injection molding under a high pressure in accordance with metal powder injection molding improves the durability of the projections 19 of the gripper 13. The sharp distal ends of the projections 19 reliably bite into the sheet 12 to provide a large holding force and frictional force with respect to the sheet 12. Therefore, a shift in gripping position of the sheet 12 is regulated and a registration error or double printing is prevented, thus improving the printing quality.

The upper surface 17 of the gripper 13 is formed with the recess 18 having the bottom surface 18a parallel to the gripping surface 16. Thus, when forming the gripper 13 by metal powder injection molding, no sink marks are formed in the gripping surface 16 of the gripper 13. Thus, nonuniformities do not occur in the heights of the large number of projections 19 integrally formed on the gripping surface 16, so that the projections 19 with uniform heights are formed. As a result, a stable gripping force can be obtained. Projection marks or holes, which may be formed when the gripping force is produced by only some projections partially, are not formed in the sheet 12.

As the method of forming the non-attaching layer 20, a method of baking fluoroplastic on the surfaces of the projections 19 has been described. Other than this, a method of coating the surfaces of the projections 19 with fluoroplastic, or a method of mixing fluoroplastic fine particles in a nickel plating solution in advance and causing fluoroplastic and a nickel plating film to deposit on the surfaces of the projections 19 simultaneously in the plating step, may be employed.

Although a case is described in which the projections 19 are formed on the gripping surface 16 of the gripper 13, the projections 19 may be formed on a gripping surface 4a of the gripper pad 4, in place of on the gripping surface 16 of the gripper 13. The projections 19 may be formed on both the gripping surface 16 of the gripper 13 and the gripping surface 4a of the gripper pad 4. Although the projections 19 have sharp-pointed distal ends, projections having flat distal ends may be formed.

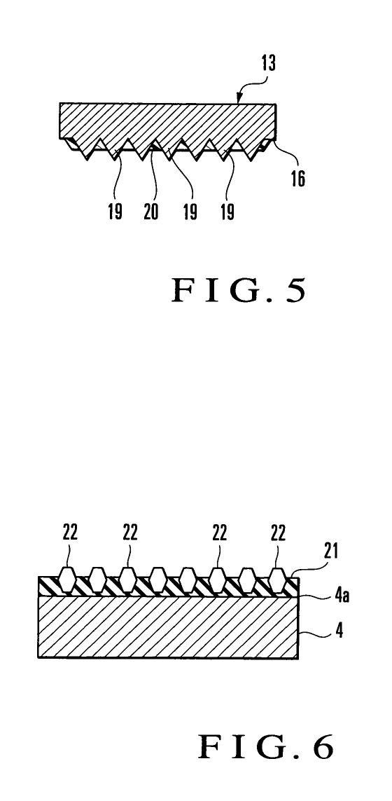

The second embodiment of the present invention will be described with reference to FIG. 5. The second embodiment is different from the first embodiment (FIG. 3) in that a non-attaching layer 20 made of fluoroplastic is formed on the gripping surface region of a gripper 13 excluding the distal ends of the projections 19. At this time, the bases of the projections 19 are buried in the non-attaching layer 20, and only the distal ends of the projections 19 project from the non-attaching layer 20.

In this manner, as the non-attaching layer 20 does not cover the distal ends of the projections 19, the gripping force for the sheet does not decrease. Meanwhile, attaching of a foreign substance to the region covered with the non-attaching layer 20 is suppressed.

The third embodiment of the present invention will be described with reference to FIG. 6. According to the third embodiment, a gripper pad 4 is dipped in a liquid mixture obtained by mixing fluoroplastic fine particles and diamond abrasive grains in a nickel plating solution. By plating, fluoroplastic and a plating nickel film are caused to deposit simultaneously on the surface of a gripping surface 4a of the gripper pad 4. Thus, a non-attaching layer 21 composed of a fluoroplastic nickel plating layer is formed to include a large number of diamond abrasive grains 22. At this time, the bases of the large number of diamond abrasive grains 22 are buried in the non-attaching layer 21 such that the distal ends of the diamond abrasive grains 22 are exposed.

In a gripping surface 16 of a gripper 13 that cooperates with such a gripper pad 4 to grip a sheet, the surfaces of projections 19 may be coated with a non-attaching layer 20, as shown in FIG. 3, or need not be coated with a non-attaching layer 20.

According to this embodiment, as the non-attaching layer 21 having a low coefficient of friction is formed on the gripping surface 4a of the gripper pad 4, attaching of a foreign substance such as paper dust, powder, or ink mist to the gripping surface 4a can be suppressed. This can prevent a decrease of the frictional force that the foreign substance can cause. Since formation of the fluoroplastic nickel plating layer and partial burial of the diamond abrasive grains can be performed simultaneously without requiring a post-process such as coating of fluoroplastic by baking, the manufacturing cost can be reduced.

In the third embodiment, the gripping surface 4a of the gripper pad 4 is processed. Alternatively, formation of the non-attaching layer 21 and partial burying of the diamond abrasive grains 22 are performed on the gripping surface 16 of the gripper 13.

Although fluoroplastic is employed in the embodiments described above as a lubricating material, a material such as graphite or molybdenum disulfide may be employed. Although a gripper device provided to an impression cylinder is described, the present invention can also be applied to a gripper device provided to a transfer cylinder, delivery chain, or swing arm shaft pregripper. Although the projections 19 are formed conically, they may be formed pyramidally. The non-attaching layer 21 need not be formed on the entire gripping surface of the gripper or gripper pad, but may be formed only locally, e.g., a part of the gripping surface corresponding to a gripping position.

As has been described above, according to the present invention, a non-attaching layer having a low coefficient of friction is formed on projections on the gripping surface of a gripper or on the gripping surface of a gripper pad. This can suppress attaching of a foreign substance to the surfaces of the projections, thus preventing a decrease in frictional force caused by the foreign substance.

What is claimed is:

1. A gripper device in a sheet-fed rotary printing press, comprising:
a gripper pad including a first gripping surface;
a gripper which includes a second gripping surface and cooperates with said gripper pad to grip a sheet;
a plurality of projections formed at least on one of said first gripping surface and said second gripping surface; and
a non-attaching layer formed at least on a region among said projections.

2. A device according to claim 1, wherein a material of said non-attaching layer comprises one element selected from the group consisting of fluoroplastic, graphite, and molybdenum disulfide.

3. A device according to claim 2, wherein fluoroplastic that constitutes said non-attaching layer coats surfaces of said projections by baking.

4. A device according to claim 2, wherein fluoroplastic that constitutes said non-attaching layer coats surfaces of said projections using coating process.

5. A device according to claim 1, wherein said non-attaching layer is formed on surfaces of said projections by causing a lubricating material containing fine particles mixed in a nickel plating solution and a nickel plating film to deposit simultaneously.

6. A device according to claim 1, wherein said non-attaching layer is formed on a region excluding distal ends of said projections.

7. A device according to claim 1, wherein said non-attaching layer is formed to bury bases of said projections.

8. A device according to claim 1, wherein said non-attaching layer is formed at least on one of said first gripping surface and said second gripping surface which include surfaces of said projections.

9. A device according to claim 1, wherein said non-attaching layer is formed on a partial region of at least one of said first gripping surface and said second gripping surface.

10. A device according to claim 1, wherein at least one of said first gripping surface and said second gripping surface is formed ruggedness-like including said projections.

11. A device according to claim 1, wherein
said projections comprise diamond abrasive grains,
said non-attaching layer comprises a fluoroplastic nickel plating layer, and
said diamond abrasive grains are formed, together with said fluoroplastic nickel plating layer, on at least one of said first gripping surface and said second gripping surface.

12. A device according to claim 1, wherein said gripper including said projections is formed by metal powder injection molding.

13. A method of manufacturing a gripper device in a sheet-fed rotary printing press, comprising the steps of:
forming a plurality of projections on at least one of a first gripping surface of a gripper pad and a second gripping surface of a gripper, the gripper pad and gripper cooperating with each other to grip a sheet;
dipping at least one of the gripper pad and the gripper in a liquid mixture of abrasive grains and a lubricating material containing fine particles mixed in a nickel plating solution; and
causing the lubricating material and a nickel plating film to simultaneously deposit on at least one of said first gripping surface and said second gripping surface, thus forming a non-attaching layer in which the abrasive grains are buried.
